(19) United States
(12) Patent Application Publication
(10) Pub. No.: US 2024/0198990 A1
(43) Pub. Date: Jun. 20, 2024

(54) ELECTROPNEUMATIC PARKING BRAKE UNIT WITH A SELF-HOLDING FUNCTION IN THE EVENT OF A FAULT

(71) Applicant: ZF CV Systems Global GmbH, Bern (CH)

(72) Inventor: Julian van Thiel, Grossburgwedel (DE)

(21) Appl. No.: 18/407,061

(22) Filed: Jan. 8, 2024

Related U.S. Application Data
(63) Continuation of application No. PCT/EP2022/066998, filed on Jun. 22, 2022.

(30) Foreign Application Priority Data
Jul. 21, 2021 (DE) 10 2021 118 895.4

(51) Int. Cl. B60T 13/38; B60T 8/171; B60T 8/172; B60T 13/68

(52) U.S. Cl. CPC B60T 13/385; B60T 8/171; B60T 8/172; B60T 13/683; B60T 2270/402

(57) ABSTRACT

An electropneumatic valve arrangement is configured to actuate a parking brake function of an electropneumatic brake system of a commercial vehicle, with a bistable pilot control unit having an electromagnetic solenoid valve, which modulates a pilot pressure in dependence on an electronic parking brake signal; and a main valve unit, which receives the pilot pressure and modulates a parking brake pressure at least at one spring accumulator connection in dependence on the pilot pressure. The solenoid valve has a safety control connection for receiving a safety control pressure, supplies the pilot control unit with supply pressure or connects it to an air-purging in dependence on the safety control pressure. The safety control pressure is a pressure modulated by the solenoid valve or a pressure derived from it. A method is for controlling a parking brake function of a commercial vehicle having an electropneumatic brake system.

### CROSS-REFERENCE TO RELATED APPLICATIONS

This application is a continuation application of international patent application PCT/EP2022/066998, filed Jun. 22, 2022, designating the United States and claiming priority from German application 10 2021 118 895.4, filed Jul. 21, 2021, and the entire content of both applications is incorporated herein by reference.

### TECHNICAL FIELD

The disclosure relates to an electropneumatic valve arrangement for actuating a parking brake function of an electropneumatic brake system of a commercial vehicle, with a bistable pilot control unit having an electromagnetic solenoid valve including a first electromagnet and a second electromagnet, wherein the pilot control unit modulates a pilot pressure in dependence on an electronic parking brake signal, and a main valve unit, which receives the pilot pressure and modulates a parking brake pressure at least at one spring accumulator connection in dependence on the pilot pressure. The disclosure also relates to a method for controlling a parking brake function of a commercial vehicle with an electropneumatic brake system and to a commercial vehicle with an electronically controllable pneumatic brake system.

### BACKGROUND

Electropneumatic valve arrangements for actuating a parking brake function are used in both Europe and the United States. A parking brake function of an electropneumatic brake system usually uses so-called spring-loaded brake cylinders, which are applied on the basis of a spring force and are open when supplied with air. These spring-loaded brake cylinders should therefore be supplied with air, and thus open, when the vehicle is driving, whereas they are purged of air, and thus applied, when the vehicle is parked.

A solution for supplying air to such spring-loaded brake cylinders is disclosed in DE 10 2017 005 757 A1. The solution disclosed there uses a pilot control unit and a main valve unit, wherein the pilot control unit includes an electromagnetic solenoid valve in the form of a bistable valve. In the solution disclosed there, the main valve unit is formed by a relay valve. Depending on the switching position of the electromagnetic bistable valve, a control pressure is modulated at the main valve unit, which then modulates a volume pressure for the spring-loaded brake cylinders in a corresponding manner. A solenoid valve which has two stable switching positions, in particular a stable air-supplying position and a stable air-purging position, is referred to as a bistable valve. One or two coils and one or two permanent magnets may be provided for this purpose. If two coils are provided, by energizing a first coil, an armature of the solenoid valve, which preferably carries a permanent magnet, can be moved into a first position, so that the solenoid valve assumes the air-supplying position and, by energizing a second coil, the armature of the solenoid valve can be moved into a second position, so that the solenoid valve assumes the air-purging position. Both end positions form latching positions in which the solenoid valve is magnetically latched. If no other force acts on the armature, or it can be mechanically and/or magnetically latched in the positions, the respective switching position is stable because it can be maintained without further energizing.

By contrast, in the US so-called push-pull valves are used in the driver's cab, via which the driver can manually bring about the supplying of air or purging of air to or from the spring-loaded brake cylinders. When the push-pull valve is pressed in, a pneumatic connection is established, so that the spring-loaded brake cylinders of the towing vehicle are supplied with air and thus released. By contrast, if the driver pulls out the push-pull valve, the spring-loaded brake cylinders are purged of air and applied. A solution that already allows pneumatic switching of the push-pull valves is disclosed in US 2019/0308599.

Since the effort involved in providing pneumatic piping from the corresponding valves that implement the parking brake function, the spring-loaded brake cylinders, which are usually provided on the rear axle, as well as the driver's cab, is relatively high, there is a need to simplify this. There is also the need to improve the safety of such push-pull valves.

A further solution that provides a pneumatic bistability or a self-holding and thus enables stable engagement of the parking brake even without further energization of an electromagnetic valve is disclosed in US 2020/0172073 and US 2023/0083111. The solution disclosed there uses as the main valve unit a pneumatically switchable 3/2-way valve and as the pilot control unit two electrically switchable 3/2-way valves, wherein one of the electrically switchable 3/2-way valves returns the pressure modulated by the main valve unit and modulates a pneumatic control connection of the main valve unit. This realizes pneumatic self-holding in the event that the main valve unit modulates a pneumatic pressure. If a fault occurs or if the supply supplying the main valve unit with supply pressure is pumped empty, the main valve unit also no longer modulates pressure, so that the main valve unit changes in a monostable manner to a different switching position, in which the corresponding spring accumulator connection is purged of air. Also if the corresponding compressed air supply is to be refilled, for example by a service technician or because the vehicle has power again, the parking brake is not automatically released again because the main valve unit is in the air-purging position and no pneumatic pressure is returned.

However, this solution, which is specifically intended for the US market, cannot be easily used in Europe, depending on the vehicle type.

### SUMMARY

It is an object of the disclosure to be able to implement further functionalities and thus provide an improved valve arrangement, as well as to be able to create synergies between individual products as far as possible.

The object is, for example, achieved in a first aspect of the disclosure in an electropneumatic valve arrangement of the type mentioned at the beginning in that the solenoid valve has a safety control connection for receiving a safety control pressure, wherein the solenoid valve supplies the pilot control unit with supply pressure or connects it to an air-purging in dependence on the safety control pressure, wherein the safety control pressure is a pressure modulated by the solenoid valve or a pressure derived from it. In this way it can be achieved that the solenoid valve does not necessarily remain in a latching position brought about by the at least one permanent magnet if the pressure modulated by the solenoid valve changes.

In the case of solutions that use a solenoid valve in the form of a conventional bistable valve in the context of electropneumatic valve arrangements for actuating the parking brake function, there is the risk that the solenoid valve will also remain in an air-supplying position after a fault in the vehicle, as a result of the magnetic force exerted by the at least one permanent magnet. If the vehicle is stopped after a fault, and as a consequence the compressed air supply is drained, the spring-loaded brake cylinders are applied even without the solenoid valve being brought into the air-purging position. It can therefore remain in the air-supplying position as a result of its two magnetic latching positions, to be specific the air-supplying position and the air-purging position. If power is supplied to the vehicle again, and as a consequence the compressed air supply is filled or the compressed air supply is filled again in some another way, the spring-loaded brake cylinders may be supplied with air and thus released, which can lead to the vehicle rolling away unintentionally. To prevent this, it is known to bring the solenoid valve into an air-purging position after the spring-loaded brake cylinders have been supplied with air, wherein the pressure modulated by the solenoid valve is confined by another, further valve, such as for example a 2/2-way valve.

In the event that in this configuration the brake system is deenergized or a control module fails, the further valve falls back into an opening position in a monostable manner. At this point in time, the solenoid valve is still in the air-purging position, so that in this event the spring-loaded brake cylinders can then be purged of air. Renewed filling of the compressed air supply also does not automatically lead in this case to the spring-loaded brake cylinders being supplied with air. Nevertheless, it can also happen in such situations that a fault occurs before the solenoid valve is brought back into the air-purging position, so that the problem described above of supplying air to the spring-loaded brake cylinders may arise when the supply pressure is restored.

According to the disclosure, therefore, the switching position of the solenoid valve is not only made dependent on the electromagnetically set switching position, but also on the modulation of the safety control pressure, that is, on the pressure modulated by the solenoid valve. This provides a further layer of security. It can preferably be provided that, as soon as the safety control pressure drops below a first predetermined threshold value, the solenoid valve is moved into an air-purging position independently of electromagnetic switching signals. This can be performed pneumatically, mechanically or in some other way. Preferably, this is performed independently of an energizing power supply.

The safety control pressure is a pressure modulated by the solenoid valve or a pressure derived from it. For example, a return line or a return hole, which provides the pressure modulated by the solenoid valve as a safety control pressure at the safety control connection, may be provided directly at a connection of the solenoid valve. However, it may also be provided that a return line branches off directly before the main valve unit, or else only downstream of it, for example before or at the spring accumulator connection. The parking brake pressure is a derived pressure modulated by the solenoid valve.

In a first embodiment, the solenoid valve has a first solenoid valve connection, receiving the supply pressure, a second solenoid valve connection, modulating the pilot pressure, and a third solenoid valve connection, connected to an air-purging. Preferably, in an air-supplying position or first switching position of the solenoid valve, the first solenoid valve connection is connected to the second solenoid valve connection and, in an air-purging position or second switching position of the solenoid valve, the third solenoid valve connection is connected to the second solenoid valve connection. By energizing at least one coil, the solenoid valve can optionally be switched into the air-supplying position or the air-purging position, wherein the solenoid valve can be held magnetically in the respective switching position via the at least one permanent magnet. It can preferably also be provided that, in the event that the safety control pressure is below a first threshold value, the solenoid valve is switched into the air-purging position independently of a previous switching position. This ensures that the solenoid valve is in the air-purging position also in a de-energized state and also in the event of a fault and that restoring a supply pressure does not directly lead to the release of spring-loaded brake cylinders. The solenoid valve may in principle have a coil and a permanent magnet, which is then preferably arranged in the armature of the solenoid valve. The armature and permanent magnet can be moved in one or the other direction via correspondingly energizing the one coil, wherein, when bearing against a corresponding valve seat, the armature is magnetically latched there, so that the solenoid valve has two magnetic latching positions. In variants, it is also possible however for two coils and one permanent magnet, two coils and two permanent magnets or one coil and two permanent magnets to be provided. If two permanent magnets are used, they are preferably attached to a valve housing and in each case act on the armature, so that they in turn magnetically hold, and thus latch, the armature in its end positions. It is also possible for more than two coils and permanent magnets to be provided in each case.

It can also be preferred that, in the event that the safety control pressure exceeds the first threshold value, the solenoid valve is held in the previous switching position, and preferably by energizing the at least one coil can optionally be switched into the air-supplying position or air-purging position. It is therefore preferably provided that, when the safety control pressure exceeds the first threshold value, the solenoid valve can be held in the air-supplying or air-purging position, depending on into which of these positions the solenoid valve were electromagnetically switched. However, it may also be provided that the solenoid valve is switched into the air-supplying switching position.

Preferably, in the event that the safety control pressure exceeds a second threshold value, which is preferably higher than the first threshold value, the solenoid valve is switched into the air-supplying position. Preferably, the solenoid valve can in this case be switched into the air-purging position by energizing the at least one coil. If the safety control pressure exceeds the second threshold value, this may not only bring about the effect that the solenoid valve remains in the switching position, but also the effect that the solenoid valve is actively switched into the air-supplying position. For this purpose, the force exerted by the safety control pressure preferably exceeds a magnetic holding force or latching torque applied by the at least one permanent magnet. Nevertheless, it is preferably provided that, by energizing the at least one coil, the solenoid valve can be switched into the air-purging position. When the coil is energized, an additional force is exerted on the armature, which in turn may exceed the force exerted by the safety control pressure, so that the armature is moved into the other switching position. By energizing the at least one coil, the modulation of the safety control pressure can thus be taken above the second threshold value in order to enforce that the air-purging position is assumed.

The first threshold value is preferably provided in a range of 200 kPa to 400 kPa, more preferably 250 kPa to 350 kPa. These values should be below the normal value of the supply pressure. The second threshold value is preferably in a range of 500 kPa to 900 kPa, preferably 600 kPa to 800 kPa.

It can also be preferred that the solenoid valve has a preferred position. This means that the solenoid valve is preferably preloaded into one of the first and second switching positions, preferably the air-purging position. Preferably, in the preferred position the pilot control unit is connected to the air-purging. It may be provided that the modulation of the safety control pressure above the first threshold value cancels the preferred position. As soon as the safety control pressure exceeds the first threshold value, the solenoid valve preferably no longer has a preferred position. However, if the safety control pressure is below the first threshold value, the solenoid valve has the preferred position and switches into the preferred position in the de-energized state, to be specific preferably into the air-purging position. The preferred position may be realized for example by spring loading of the solenoid valve into the preferred position. This ensures that the solenoid valve is mechanically loaded into the preferred position and that it is moved into this preferred position when the safety control pressure is below the threshold. In this case, the safety control pressure thus counteracts the spring force.

In a further embodiment, an emergency release connection is provided, with an emergency release path for inputting an emergency release pressure, which brings about the modulation of the parking brake pressure at the at least one spring accumulator connection. The emergency release connection serves in particular for activating the emergency release pressure manually or by a further pressure source, in order to modulate the parking brake pressure at the at least one spring accumulator connection. This then allows the spring-loaded brake cylinder or cylinders to be supplied with air and released via the modulation of the emergency release pressure. This may be necessary and helpful when the commercial vehicle has no electrical power or is defective and the compressed air supply that is supplying the spring accumulator connection cannot provide sufficient pressure or sufficient volume. In this way, for example, a service technician can modulate the emergency release pressure, for example by way of a supply that is present in a service vehicle, and thus release the spring-loaded brake cylinder or cylinders.

In one variant, the solenoid valve supplies the pilot control unit with supply pressure or connects it to the air-purging in dependence on the emergency release pressure. For example, the emergency release path may enter an air-purging path of the solenoid valve. For example, it is thus conceivable and preferred that the emergency release path enters via a check valve or a double check valve into the air-purging path, in order in this way to modulate a control pressure via the air-purging path of the solenoid valve. The solenoid valve is intended to be in the air-purging position when the vehicle has no electrical power or no pressure, and connect the pilot control unit to the air-purging. This means that, in this switching position, the emergency release pressure can be input via the air-purging path in order to provide the pilot control unit in this way with the corresponding control pressure. This in turn can then bring about the modulation of the parking brake pressure.

It is also preferred that the emergency release pressure is modulated via the emergency release path at the safety control connection of the solenoid valve or at a further control connection of the solenoid valve. This allows the solenoid valve to be brought again into the first switching position, in which the solenoid valve is preferably in an air-supplying position, in order thus to modulate a pilot pressure at the main valve unit. For this purpose, the emergency release pressure may be modulated at the same safety control connection of the solenoid valve at which the safety control pressure is also modulated, or at a separate further control connection provided for this purpose. Both can bring about the triggering of the preferred position and/or can switch the solenoid valve into the air-supplying position.

In a further embodiment it is provided that, in the event that the emergency release pressure exceeds a or the second threshold value, the solenoid valve is switched into the air-supplying position. According to this embodiment, therefore, not only is the preferred position canceled, but also the air-supplying position is adopted over the preferred position. Preferably, it is however also provided here that the is overmodulated by correspondingly energizing the at least one coil, and thus the solenoid valve can be switched into the air-purging position in spite of the emergency release pressure above the second threshold value.

It can also be preferred that the electropneumatic valve arrangement is integrated in a module, which preferably has one or more supply connections, the spring accumulator connection, an air-purging and optionally an emergency release connection. Such a module may be configured in particular as a parking brake module. Preferably, such a module has its own electronic control unit, which can receive one or more signals of a higher-level control unit, for example via a vehicle BUS, some other BUS or direct wiring. The electronic control unit of the module can then output one or more switching signals to the electromagnetically switchable valve or valves to bring about a switching. However, it may also be provided that the individual electromagnetic valves of the electropneumatic valve arrangement are switched via a direct signal modulation of a higher-level control unit. A higher-level control unit may be in particular a central processing unit, a vehicle control unit or the like.

In a second aspect, a method for controlling a parking brake function of a commercial vehicle with an electropneumatic brake system and preferably an electropneumatic valve arrangement according to one of the embodiments described above of an electropneumatic valve arrangement according to the first aspect of the disclosure, has the steps of: electromagnetically switching an electromagnetic solenoid valve with at least one first permanent magnet from an air-purging position into an air-supplying position for modulating a parking brake pressure at least at one spring accumulator connection for supplying air to at least one spring-loaded brake cylinder, confining a pilot pressure modulated by the solenoid valve and/or holding the solenoid valve in the air-purging position, and, when a supply pressure provided to the solenoid valve drops below a first threshold value: pneumatically or mechanically switching the solenoid valve into the air-purging position.

It should be understood that the method according to the second aspect and the electropneumatic valve arrangement according to the first aspect of the disclosure have the same and similar sub-aspects. In this respect, reference is made to the above description of the first aspect of the disclosure in full.

The electromagnetic switching of the solenoid valve from an air-purging position into an air-supplying position preferably takes place by energizing at least one coil. By energizing the at least one coil, and possibly a further coil, the solenoid valve can be optionally switched into the air-supplying or air-purging position.

It can preferably be provided in the method that the solenoid valve has a preferred position, which can be canceled by modulating a safety control pressure at a safety control connection of the solenoid valve. That is, that, if no safety control pressure or too low a safety control pressure has been modulated at the safety control connection, the solenoid valve has the preferred position; if the safety control pressure exceeds the first threshold value, this preferred position is canceled or equalized, so that the solenoid valve then has no preferred position.

The method can preferably also include the step of: modulating a safety control pressure at a safety control connection of the solenoid valve for holding the solenoid valve in the air-purging position or for switching the solenoid valve into the air-purging position, wherein the safety control pressure is a pressure modulated by the solenoid valve or derived from it. For this purpose, the safety control pressure preferably exceeds the first threshold value.

The method may include the step of: modulating an emergency release pressure for modulating the parking brake pressure at the at least one spring accumulator connection. The emergency release pressure may be input into an air-purging path of the solenoid valve. In addition or as an alternative, the emergency release pressure may also be modulated at the safety control connection of the solenoid valve or at a further control connection of the solenoid valve. If the safety control pressure modulated at the safety control connection or the emergency release pressure exceeds a or the second threshold value, the solenoid valve is preferably switched into the air-supplying position independently of its previous switching position. Also in this case it may be provided however that the solenoid valve can be switched into the air-purging position by energizing the at least one coil.

In a third aspect, the disclosure achieves the object mentioned at the beginning by a commercial vehicle with an electronically controllable pneumatic brake system, which has an electropneumatic valve arrangement according to one of the embodiments described above of an electropneumatic valve arrangement according to the first aspect of the disclosure. Preferably, the commercial vehicle is configured to carry out the method according to the second aspect of the disclosure at least partially.

It should be understood that the electropneumatic valve arrangement according to the first aspect of the disclosure, the method according to the second aspect of the disclosure and the commercial vehicle according to the third aspect of the disclosure have the same and similar sub-aspects. In this respect, reference is made to the above description in full. The electropneumatic valve arrangement according to the first aspect of the disclosure can be implemented in the commercial vehicle according to the third aspect of the disclosure in particular in the form of a parking brake module.

### BRIEF DESCRIPTION OF DRAWINGS

The invention will now be described with reference to the drawings wherein:

FIG. 1 shows a first embodiment of an electropneumatic valve arrangement;

FIG. 2 shows a second embodiment of an electropneumatic valve arrangement;

FIG. 3 shows a third embodiment of an electropneumatic valve arrangement; and,

FIG. 4 shows a commercial vehicle.

### DETAILED DESCRIPTION

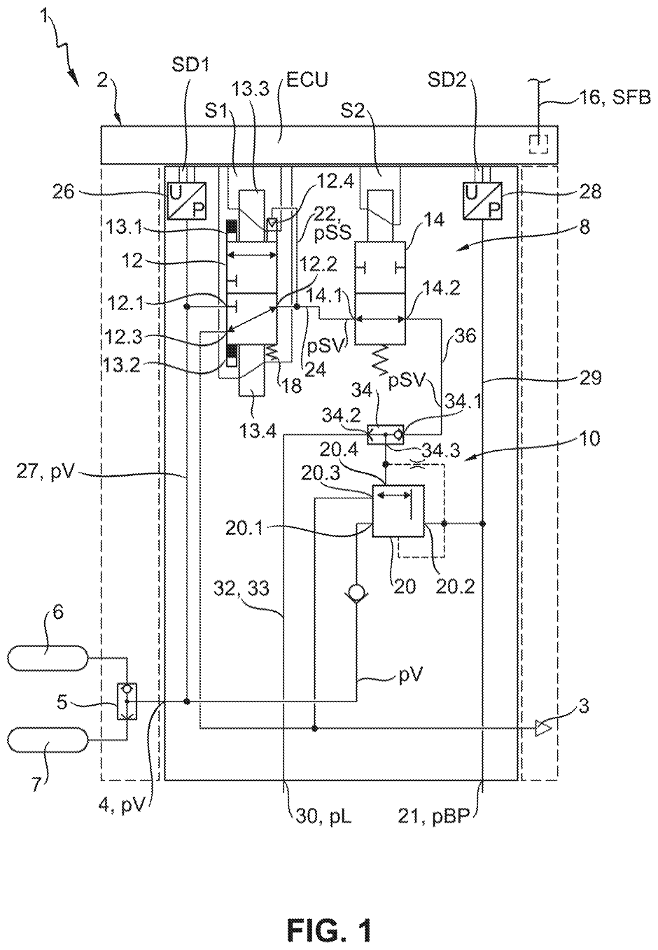

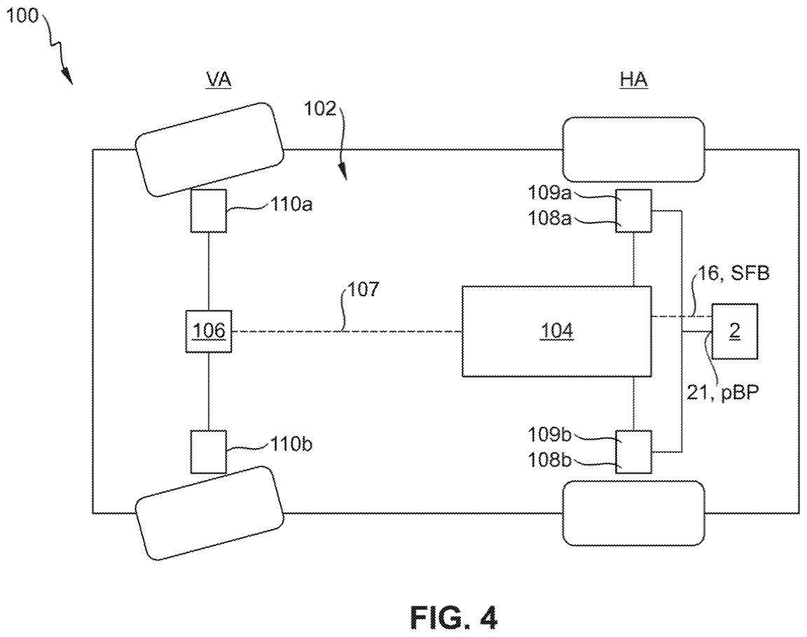

An electropneumatic valve arrangement 1 is configured in the embodiment shown in FIGS. 1 to 3 as a parking brake module 2, though this is not absolutely necessary and the electropneumatic valve arrangement 1 may rather also be integrated with other units and/or the individual valves described below may also be arranged separately and/or distributed in a brake system 102 (see FIG. 4).

The parking brake module 2 has a supply connection 4, to which a first compressed air supply 6 and a second compressed air supply 7 are connected via a supply shuttle valve 5, each providing a supply pressure pV, so that the supply pressure pV is applied to the supply connection 4. It is not absolutely necessary that two compressed air supplies 6, 7 are connected to the supply connection 4; rather, it may also be sufficient if only one compressed air supply is connected there, or the supply connection 4 is supplied via a further module.

The electropneumatic valve arrangement 1 has a bistable pilot control unit 8 and a main valve unit 10. The bistable pilot control unit 8 has an electromagnetic solenoid valve 12. The solenoid valve 12 has a first solenoid valve connection 12.1, a second solenoid valve connection 12.3 and a third solenoid valve connection 12.3. The first solenoid valve connection 12.1 is connected to the supply connection 4 and receives supply pressure pV. The second solenoid valve connection 12.2 is connected to the main valve unit 10, in the embodiment shown in FIG. 1 via a holding valve 14. The third solenoid valve connection 12.3 is connected to an air-purging 3. The solenoid valve 12 has a first switching position, not shown in FIG. 1, in which the first solenoid valve connection 12.1 is connected to the second solenoid valve connection 12.2. In the second switching position shown in FIG. 1, the third solenoid valve connection 12.3 is connected to the second solenoid valve connection 12.2. In this respect, the first switching position may also be referred to as the air-supplying position and the second switching position as the air-purging position. In the air-supplying position, a pilot pressure pSV is modulated via the solenoid valve 12. The solenoid valve 12 is switched in dependence on a parking brake signal SFB, which is received from the parking brake module 2, for example via a vehicle BUS 16, or may also be provided directly at the solenoid valve 12.

The solenoid valve 12 has a first permanent magnet 13.1 and a second permanent magnet 13.2. In addition, in the embodiment shown the solenoid valve 12 also has a first coil 13.3 and a second coil 13.4. In dependence on the parking brake signal SFB, either the first coil 13.3 or the second coil 13.3 is energized. If the first coil 13.3 is energized, an armature of the solenoid valve 12 is attracted in a manner known in principle and so the solenoid valve 12 is switched into the air-supplying position. The armature is then held by the first permanent magnet 13.1 in the air-supplying position, which is accordingly a magnetic latching position. The first permanent magnet 13.1 and the first coil 13.3 are assigned to the air-supplying position. If, by contrast, the second coil 13.4 is energized, the armature is pulled into the opposite latching position and the solenoid valve 12 is switched into the air-purging position. In this latching position, the armature is held by the second permanent magnet 13.2. In principle, however, only one coil 13.3, 13.4 could also be provided, which is then to be reversed in its polarity to switch the solenoid valve 12 to the air-supplying position and the air-purging position. It is also conceivable that only a permanent magnet 13.1, 13.2 is provided, which is then preferably arranged on the armature of the solenoid valve 12.

In the embodiment shown in FIG. 1, the parking brake module 2 is equipped with its own electronic control unit ECU, even if this is not mandatory, and receives the parking brake signal SFB and then as a result modulates at least one first switching signal S1 at the solenoid valve 12 in order to selectively switch it between the first and the second switching position. In the event that the parking brake module 2 does not have its own electronic control unit ECU, the first switching signal S1 may also be provided directly by an external control unit. The solenoid valve 12 can be switched into the first or second switching position respectively by a pulse. In the embodiment shown, the solenoid valve 12 in addition to conventional solenoid valves has a preferred position, to be specific the solenoid valve 12 is preloaded into the second switching position shown in FIG. 1. For this purpose, a spring 18 is provided, which brings the solenoid valve 12 into the second switch position shown in FIG. 1 (air-purging position).

The pilot pressure pSV modulated by the solenoid valve 12 is provided via the holding valve 14 at the main valve unit 10. The main valve unit 10 includes a relay valve 20, which has a relay valve supply connection 20.1, a relay valve working connection 20.2, a relay valve air-purging connection 20.3 and a relay valve control connection 20.4. The relay valve supply connection 20.1 is connected to the supply connection 4 and receives supply pressure pV. The relay valve working connection 20.2 is connected to a spring accumulator connection 21 of the parking brake module 2, at which the main valve unit 10 modulates a parking brake pressure pBP. The relay valve air-purging connection 20.3 is connected to the air-purging 3, and the relay valve control connection 20.4 is connected to the pilot control unit 8 and receives the pilot pressure pSV. One or more spring-loaded brake cylinders 108a, 108b (cf. FIG. 4), which release when they are supplied with air and are applied via a spring force when they are purged of air, may be connected to the spring accumulator connection 21.

In order to release the spring-loaded brake cylinders 108a, 108b, the spring accumulator connection 21 must therefore be supplied with air, so that the parking brake pressure pBP is modulated. For this purpose, the solenoid valve 12 is moved from the air-purging position shown in FIG. 1 into the air-supplying position, not shown in FIG. 1, so that the pilot pressure pSV is modulated. The holding valve 14 is in the open switching position. The holding valve 14 has a first holding valve connection 14.1 and a second holding valve connection 14.2, wherein the first holding valve connection 14.1 is connected to the solenoid valve 12, more precisely to the second solenoid valve connection 12.2, and receives the pilot pressure pSV. The second holding valve connection 14.2 is connected to the main valve unit 10, more specifically to the relay valve control connection 20.4. The holding valve 14 is configured to be electromagnetic and monostable and can be brought from the stable first switching position shown in FIG. 1, which is an opening position, into a second closed, non-stable switching position, by providing a second switching signal S2 by energizing an electromagnet in the holding valve 14. If the solenoid valve 12 is thus first switched so that the pilot pressure pSV is modulated and the holding valve 14 is open, the pilot pressure pSV is passed on and modulated at the relay valve control connection 20.2, which then as a consequence increases this pressure with increased volume and modulates the parking brake pressure pBP at the spring accumulator connection 21. Then the holding valve 14 can be moved into the closed second switching position, so that the pilot pressure pSV is confined between the second holding valve connection 14.2 and the relay valve control connection 20.4. The solenoid valve 12 can then be brought back to the first air-purging position shown in FIG. 1. The spring-loaded brake cylinders 108a, 108b nevertheless still remain supplied with air and thus released. Even if only a variant with pilot control unit 8 and main valve unit 10 is described here, it should be understood that the main valve unit 10 is not absolutely necessary and the pilot pressure pSV could similarly be modulated directly as the parking brake pressure pBP. In this case, the second holding valve connection 14.2 would be connected to the spring accumulator connection 21 without intermediate connection of the main valve unit 10.

As another control mechanism, the holding valve 14 may however also remain open in its stable switching position. In order then to hold the solenoid valve 12 in the first air-supplying position, not shown in FIG. 1, the solenoid valve 12 has a safety control connection 12.4. The safety control connection 12.4 is connected via a safety line 22 to a first control line 24, which connects the second solenoid valve connection 12.2 and the first holding valve connection 14.1. The safety line 22 thus returns the pressure modulated by the solenoid valve 12 to the safety control connection 12.4. If the pilot pressure pSV is modulated by the solenoid valve 12, it is provided via the safety line 22 to the safety control connection 12.4, so that it is applied as a safety control pressure pSS to the solenoid valve 12. The safety control connection 12.4 is arranged so that the safety control pressure pSS acts on the solenoid valve 12 so that the latter is loaded into the first switching position, not shown in FIG. 1, that is, the air-supplying position. In particular, internal control surfaces are chosen such that the safety control pressure pSS exerts approximately a force effect matching the spring 18, so that the preferred position of the solenoid valve 12 can be canceled or neutralized by applying the safety control pressure pSS. In this state, the solenoid valve 12 can also be switched into the air-supplying or air-purging position by corresponding energization of the first and second coils 13.3, 13.4, because the spring 18 and the safety control pressure pSS substantially neutralize each other. In the respective switching positions, the magnetic force of either the first or second permanent magnet 13.1, 13.2 then acts, so that the switching positions are latching positions, and the armature can only be brought from the respective latching positions by overcoming the magnetic forces by applying a certain minimum force.

However, if the safety control pressure pSS drops below a first threshold value, which may for instance lie in a range of 200 kPa to 400 kPa, the force effect by the safety control pressure pSS is lower than that of the spring force by the spring 18, so that the solenoid valve 12 has a preferred position again and falls back into the second air-purging position shown in FIG. 1. Thus, if, in the event of a fault in the commercial vehicle 100, the supply pressure pV drops because both the first and the second compressed air supply 6, 7 are emptied, have a leak or are actively pumped down by the driver, the pilot pressure pSV also drops when the solenoid valve 12 is in the air-supplying position, not shown in FIG. 1. However, if the pilot pressure pSV drops, the safety control pressure pSS also drops at the same time, so that, from a certain point, to be specific preferably when it falls below the first threshold value, the preferred position of the solenoid valve 12 engages again and the spring 18 brings the solenoid valve 12 into the air-purging position shown in FIG. 1, so that, as a consequence of this, the relay valve control connection 20.4 is purged of air and the parking brake pressure pBP is no longer modulated. The spring-loaded brake cylinders 108a, 108b are purged of air completely.

If, in this state, the first and/or second compressed air supply 6, 7 should be refilled, for example because the commercial vehicle 100 has energy again or the first and second compressed air supplies 6, 7 are filled by a service technician, the solenoid valve 12 is nevertheless in the second air-purging position shown in FIG. 1 and the spring accumulator connection 21 is not automatically and unintentionally supplied with air. Only by providing the parking brake signal SFB or first switching signal S1 and energizing the first coil 13.3 can the solenoid valve 12 be brought back into the air-supplying position, not shown in FIG. 1, for supplying air, so that the spring-loaded brake cylinders 108a, 108b can be released again. Unintentional release of the spring-loaded brake cylinders 108a, 108b is effectively prevented.

In the embodiment shown here (FIG. 1), the parking brake module 2 also has a first pressure sensor 26 and a second pressure sensor 28. The first pressure sensor 26 is connected to the supply connection 4 via a first pressure measuring line 27 and thus measures the supply pressure pV and provides a corresponding first pressure signal SD1 at the electronic control unit ECU. The second pressure sensor 28 is connected to the spring accumulator connection 21 via a second pressure measuring line 29 and thus determines the parking brake pressure pBP and provides a corresponding second pressure signal SD2 at the electronic control unit ECU. The first and second pressure signals SD1, SD2 can be used to verify and check the plausibility of the modulation of the pressures and the switching position of the individual valves.

According to the embodiment shown here, the electropneumatic valve arrangement 1 also has a release control connection 30. Such a release control connection 30, via which a release control pressure pL can be input, is also referred to as an anti-compound connection. The release control connection 30 is connected to a release control path 32. The release control pressure pL input via the release control connection 30 brings about the modulation of the parking brake pressure pBP at the at least one spring accumulator connection 21. The release control path 32 includes a release line 33, which extends from the release control connection 30. The release control pressure pL used is typically the pressure of a further axle, for example the front or rear axle, in particular the service brake pressure. In the event that the spring-loaded brake cylinders 108a, 108b connected to the spring accumulator connection 21 are also used for auxiliary braking or emergency braking, this is intended to prevent excessive actuation of the spring-loaded brake cylinders 108a, 108b, which could lead to locking of the vehicle 100. So, if service brakes are activated on the rear axle, as far as possible the spring-loaded brake cylinders 108a, 108b should not be engaged at the same time either, so that it is advisable to provide the service brake pressure of the rear axle as release control pressure pL to the release control connection 30 in order to release the spring-loaded brake cylinders 108a, 108b conversely to engage the service brakes.

In the embodiment shown in FIG. 1, the release control line 33 is connected to a shuttle valve 34. The release control pressure pL can be supplied to the relay valve control connection 20.4 via the release control path 32. The shuttle valve 34 has a first shuttle valve connection 34.1, a second shuttle valve connection 34.2 and a third shuttle valve connection 34.3. The shuttle valve 34 is configured so that it passes on in each case the higher of the pressure of the pressure applied to the first and second shuttle valve connections 34.1, 34.2 to the third shuttle valve connection 34.3. The first shuttle valve connection 34.1 is connected here to the second holding valve connection 14.2 via a second control line 36, but may also be connected directly to the second holding valve connection 14.2 or else to the solenoid valve 12. In any case, the first shuttle valve connection 34.1 is connected to the pilot control unit 8 and receives the pilot pressure pSV. The second shuttle valve connection 34.2 is connected to the release control connection 30 and receives the release control pressure pL. The third shuttle valve connection 34.3 is connected to the relay valve control connection 20.4, so that in each case the higher of the pilot pressure pSV or the release control pressure pL is modulated to the relay valve control connection 20.4, in order thus to bring about the modulation of the parking brake pressure pBP.

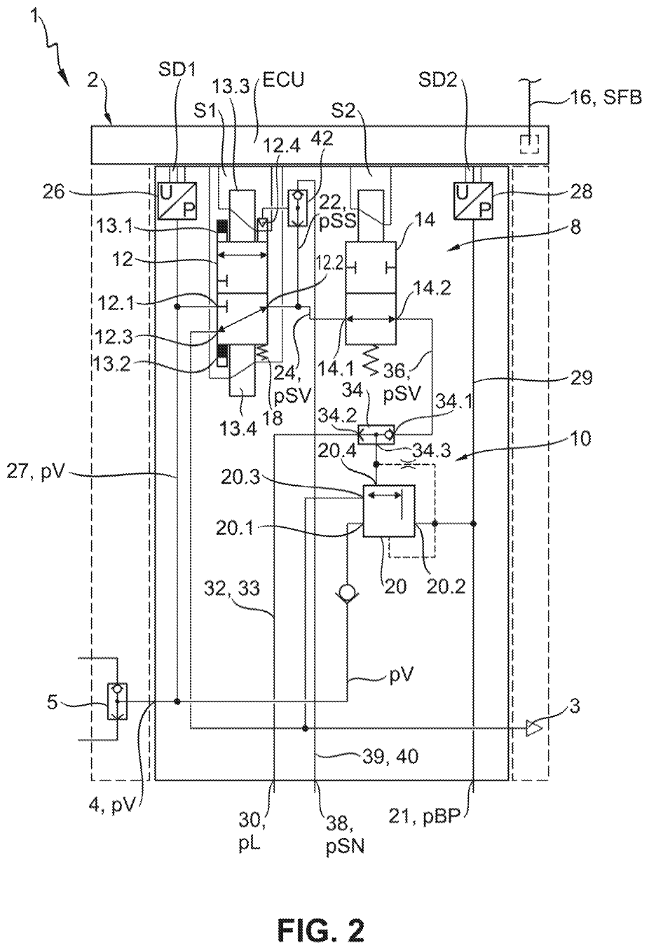

The second embodiment shown in FIG. 2 is based in principle on the first embodiment (FIG. 1), so that identical and similar elements are provided with the same reference signs. In this respect, reference is made to the above description of the first embodiment (FIG. 1) in full. In the following, the differences from the first embodiment are highlighted in particular.

The essential difference in the second embodiment (FIG. 2) is that an emergency release connection 38 is provided, via which an emergency release pressure pSN can be supplied. In this embodiment, the emergency release connection 38 is connected via an emergency release path 39 to the solenoid valve 12, more precisely to the safety control connection 12.4, and can provide the emergency release pressure pSN at the safety control connection 12.4. For this purpose, an emergency release shuttle valve 42, which is connected to the emergency release connection 38 via an emergency release line 40, is switched between the safety line 22 and the safety control connection 12.4. Like the first shuttle valve 34, the emergency release shuttle valve 42 is configured so that in each case the higher of the safety control pressure pSS or emergency release pressure pSN is modulated at the safety control connection 12.4. In this way, the solenoid valve 12 can be moved from the first switching position shown in FIG. 2 to the second air-supplying position, not shown in FIG. 2, in particular when the emergency release pressure pSN exceeds a second threshold value, which preferably lies in a range of 400 kPa to 800 kPa and exceeds the force applied by the spring 18 and optionally a latching force for the armature of the solenoid valve, which holds it in the air-purging position, so that the solenoid valve 12 can switch over. In this way, the supply pressure pV can then be provided to the pilot control unit 8 in order in this way to modulate the pilot pressure pSV and consequently to supply air to the spring accumulator connection 21. The emergency release pressure pSN is used in particular to switch the solenoid valve 12 in the event that the switching signal S1 cannot be provided. For example, the emergency release pressure pSN may be a manually modulated pressure supplied via an externally connected container, such as for example a tire pressure. However, the pressure of a further compressed air supply, a further module, a further axle or the like, not shown here, may also be used. The emergency release pressure pSN is used in particular to supply air to the spring accumulator connection 21 in the event that the solenoid valve 12 can no longer be electronically switched into the air-supplying position. For example, the solenoid valve 12 could in this way be reset by the service brake pressure of a further axle.

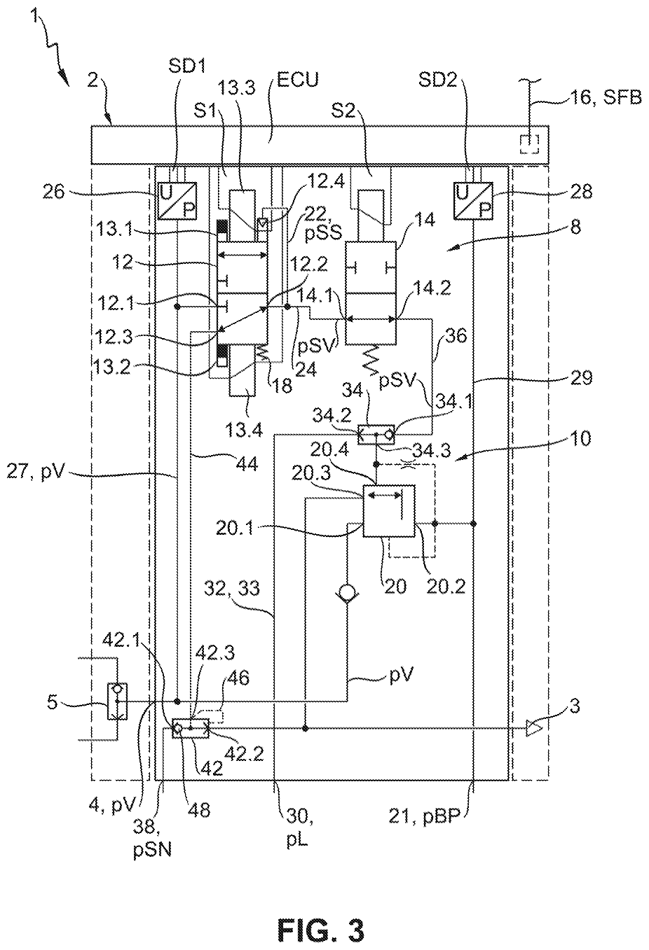

A variant of this is shown in FIG. 3. FIG. 3 is based in turn on FIGS. 1 and 2, and identical and similar elements are provided with the same reference numerals, so that reference is made to the above description of the first and second embodiments (FIG. 1, FIG. 2) in full. In the following, the differences from the first and second embodiment are highlighted in particular.

As a difference from the first embodiment (FIG. 1), the electropneumatic valve arrangement 1 according to the third embodiment (FIG. 3) in turn has the emergency release connection 38. As a difference from the second embodiment (FIG. 2), however, this emergency release connection is not connected to the safety control connection 12.4 of the solenoid valve 12, but rather enters an air-purging path 44 of the pilot control unit 8, more precisely of the solenoid valve 12. In this connection, the emergency release connection 38 is thus connected in turn to the solenoid valve 12, but to the third solenoid valve connection 12.3. Via the emergency release connection 38, the emergency release pressure pSN can thus be modulated via the air-purging path 44 at the third solenoid valve connection 12.4, so that when the solenoid valve 12 is in the air-purging position, this connection in turn causes the modulation of the pilot pressure pSV. In this case, the holding valve 14 is de-energized in the open switching position shown in FIG. 3, so that the pilot pressure pSV can be modulated via the emergency release pressure pSN at the main valve unit 10, so that the main valve unit 10 can consequently modulate the parking brake pressure pBP. The third embodiment (FIG. 3) is thus not based, like the second embodiment (FIG. 2), on a manual or pneumatic additional switching of the solenoid valve 12 into the air-supplying position but rather uses the air-purging path 44 of the solenoid valve 12 in order via this path to input the emergency release pressure, and in this way to bring about a release of the spring-loaded brake cylinders 108a, 108b.

In order to allow the inputting of the emergency release pressure pSN into the air-purging path 44, which must also be connected to the air-purging 3, the emergency release shuttle valve 42 is also used in this case, as in the second embodiment (FIG. 2). This is arranged in such a way that it allows on the one hand a connection between the pilot control unit 8 and the air-purging 3, but on the other hand also the inputting of the emergency release pressure pSN via the air-purging path 44 to the pilot control unit 8. For this purpose, the emergency release shuttle valve 42 has a first emergency release shuttle valve connection 42.1, which is connected to the emergency release connection 38. It has a second emergency release shuttle valve connection 42.2, which is connected to the air-purging 3, and a third emergency release shuttle valve connection 42.3, which then in turn is connected to the third solenoid valve connection 12.3. The emergency release shuttle valve 42 also has a preferred position and is thus preferably configured as a single check valve. To realize the preferred position, a return line 46 is provided, which has the effect that a valve element 48 pneumatically closes the first emergency release shuttle valve connection 42.1. In the basic state and when the pilot control unit 8 is purged of air via the air-purging path 44, the valve element 48 is in this way preloaded and the second and third emergency release shuttle valve connections 42.2, 42.3 are connected. Only when the emergency release pressure pSN is input against the pressureless air-purging path 44 is the valve element 48 lifted from the position shown in FIG. 3 and releases the first emergency release shuttle valve connection 42.1. Apart from this being realized pneumatically via the return 46, this can also be released mechanically via a spring. It is just preferred that, without pressure and in the air-purging mode, the second and third emergency release shuttle valve connections 42.2, 42.3 are connected to each other permanently and unhindered.

Finally, FIG. 4 illustrates a vehicle 100, to be specific a commercial vehicle, with a brake system 102, which is configured here as an electronically controllable pneumatic brake system. The vehicle 100 has a front axle VA and a rear axle HA. A central processing module 104, which is also configured as a rear axle modulator, brakes the rear axle HA, and a front axle modulator 106 is assigned to the front axle VA. The central processing module 104 and the front axle modulator 106 are connected to each other via an electronic line 107 and thus exchange signals, such as in particular brake signals. In addition to first and second spring-loaded brake cylinders 108a, 108b, also provided on the rear axle HA are first and second service brake cylinders 109a, 109b, which can be accommodated together with the spring-loaded brake cylinders 108a, 108b in so-called tristop cylinders. On the front axle VA, the front axle modulator 106 controls corresponding brake pressures at front axle service brake cylinders 110a, 110b. The spring-loaded brake cylinders 108a, 108b are controlled via a parking brake module 2, in which the electropneumatic valve arrangement 1 according to the disclosure is implemented. The parking brake module 2 has the spring accumulator connection 21, which, as shown in FIG. 4, is connected to the spring-loaded brake cylinders 108a, 108b. The vehicle BUS 16 connects the parking brake module 2 to the central processing unit 104.

It is understood that the foregoing description is that of the preferred embodiments of the invention and that various changes and modifications may be made thereto without departing from the spirit and scope of the invention as defined in the appended claims.

### List of Reference Signs (Part of the Description)

1 Electropneumatic valve arrangement

2 Parking brake module

3 Air-purging

4 Supply connection

5 Supply shuttle valve

6 First compressed air supply

7 Second compressed air supply

8 Pilot control unit

10 Main valve unit

12 Electromagnetic solenoid valve

12.1 First solenoid valve connection

12.2 Second solenoid valve connection

12.3 Third solenoid valve connection

12.4 Safety control connection

13.1 First permanent magnet

13.2 Second permanent magnet

13.3 First coil

13.4 Second coil

14 Holding valve

14.1 First holding valve connection

14.2 Second holding valve connection

16 Vehicle BUS

18 Spring

20 Relay valve

20.1 Relay valve supply connection

20.2 Relay valve working connection

20.3 Relay valve air-purging connection

20.4 Relay valve control connection

21 Spring accumulator connection

22 Safety line

24 First control line

26 First pressure sensor

27 First pressure measuring line

28 Second pressure sensor

29 Second pressure measuring line

30 Release control connection

32 Release control path

33 Release line

34 Shuttle valve

34.1 First shuttle valve connection

34.2 Second shuttle valve connection

34.3 Third shuttle valve connection

36 Second control line

38 Emergency release connection

39 Emergency release path

40 Emergency release line

42 Emergency release shuttle valve

42.1 First emergency release shuttle valve connection

42.2 Second emergency release shuttle valve connection

42.3 Third emergency release shuttle valve connection

44 Air-purging path

46 Return

48 Valve element

100 Commercial vehicle

102 Brake system

104 Central processing module

106 Front axle modulator

108a, 108b Spring-loaded brake cylinder

109a, 109b Service brake cylinder on the rear axle

110a, 110b Service brake cylinder on the front axle

ECU Electronic control unit

pBP Parking brake pressure

pL Release control pressure

pSN Emergency release pressure

pSS Safety control pressure

pSV Pilot pressure

pV Supply pressure

S1 First switching signal

S2 Second switching signal

SFB Parking brake signal

SD1 First pressure signal

SD2 Second pressure signal

VA Front axle

HA Rear axle

1. An electropneumatic valve arrangement for actuating a parking brake function of an electropneumatic brake system of a commercial vehicle, the electropneumatic valve arrangement comprising:
a pilot control unit including an electromagnetic solenoid valve having at least one first permanent magnet, wherein said pilot control unit is configured to modulate a pilot pressure in dependence upon an electronic parking brake signal;
a main valve unit configured to receive the pilot pressure and modulate a parking brake pressure at least at one spring accumulator connection in dependence upon the pilot pressure;
said electromagnetic solenoid valve having a safety control connection for receiving a safety control pressure; and,
said electromagnetic solenoid valve being configured to supply said pilot control unit with a supply pressure or connect said pilot control unit to an air-purging in dependence on the safety control pressure, wherein the safety control pressure is a pressure modulated by said electromagnetic solenoid valve or a pressure derived from said electromagnetic solenoid valve.

2. The electropneumatic valve arrangement of claim 1, wherein:
said electromagnetic solenoid valve has a first solenoid valve connection configured to receive the supply pressure, a second solenoid valve connection configured to modulate the pilot pressure, and a third solenoid valve connection connected to the air-purging;
wherein, in an air-supplying position of said electromagnetic solenoid valve, said first solenoid valve connection is connected to said second solenoid valve connection and, in an air-purging position of said electromagnetic solenoid valve, the third solenoid valve connection is connected to the second solenoid valve connection;
said electromagnetic solenoid valve has at least one permanent magnet and a coil;
wherein, by energizing said coil, said electromagnetic solenoid valve is configured to be switchable into the air-supplying position or the air-purging position, wherein said electromagnetic solenoid valve is configured to be holdable magnetically in the respective switching position via said at least one permanent magnet; and,
wherein, in the event that the safety control pressure is below a first threshold value, said electromagnetic solenoid valve is switched into the air-purging position independently of a previous switching position.

3. The electropneumatic valve arrangement of claim 2, wherein, in an event that the safety control pressure exceeds the first threshold value, said electromagnetic solenoid valve is held in a previous switching position.

4. The electromagnetic valve arrangement of claim 3, wherein said electromagnetic solenoid valve is configured to, by energizing said coil, be switchable into the air-supplying position or the air-purging position.

5. The electropneumatic valve arrangement of claim 3, wherein, in an event that the safety control pressure exceeds a second threshold value, which is higher than said first threshold value, said electromagnetic solenoid valve is switched into the air-supplying position and is configured to be switchable into the air-purging position by energizing said coil.

6. The electropneumatic valve arrangement of claim 2, wherein the first threshold value lies in a range of at least one of 200 kPa to 400 kPa and 250 kPa to 350 kPa.

7. The electropneumatic valve arrangement of claim 5, wherein the second threshold value lies in a range of at least one of 500 kPa to 900 kPa and 600 kPa to 800 kPa.

8. The electropneumatic valve arrangement of claim 1, wherein said electromagnetic solenoid valve has a preferred position.

9. The electropneumatic valve arrangement of claim 8, wherein in said preferred position said pilot control unit is connected to the air-purging.

10. The electropneumatic valve arrangement of claim 1 further comprising an emergency release connection having an emergency release path for inputting an emergency release pressure which brings about the modulation of the parking brake pressure at said at least one spring accumulator connection.

11. The electropneumatic valve arrangement of claim 10, wherein said electromagnetic solenoid valve is configured to supply said pilot control unit with supply pressure or connects said pilot control unit to an air-purging in dependence upon the emergency release pressure.

12. The electropneumatic valve arrangement of claim 10, wherein the emergency release path enters an air-purging path of said electromagnetic solenoid valve.

13. The electropneumatic valve arrangement of claim 2 further comprising:
an emergency release connection having an emergency release path for inputting an emergency release pressure which brings about the modulation of the parking brake pressure at said at least one spring accumulator connection; and,
wherein the emergency release pressure is modulated via said emergency release path at said safety control connection of said electromagnetic solenoid valve or a further control connection of said electromagnetic solenoid valve.

14. The electropneumatic valve arrangement of claim 13, wherein, in an event that the emergency release pressure exceeds a second threshold value, said solenoid valve is switched into the air-supplying position.

15. A method for controlling a parking brake function of a commercial vehicle having an electropneumatic brake system, the method comprising:
electromagnetically switching an electromagnetic solenoid valve having at least one first permanent magnet from an air-purging position into an air-supplying position for modulating a parking brake pressure at least at one spring accumulator connection for supplying air to at least one spring-loaded brake cylinder;
at least one of confining a pilot pressure modulated by the electromagnetic solenoid valve and holding the electromagnetic solenoid valve in the air-purging position; and,
when a supply pressure provided to the electromagnetic solenoid valve drops below a first threshold value: pneumatically or mechanically switching the solenoid valve into the air-purging position.

16. The method of claim 15, wherein the electromagnetic solenoid valve has a preferred position, which can be canceled by modulating a safety control pressure at a safety control connection of the electromagnetic solenoid valve.

17. The method of claim 15 further comprising:
modulating a safety control pressure at a safety control connection of the electromagnetic solenoid valve for holding the electromagnetic solenoid valve in the air-purging position or for switching the electromagnetic solenoid valve into the air-purging position, wherein the safety control pressure is a pressure modulated by the electromagnetic solenoid valve or derived from it.

18. The method of claim 15 further comprising modulating an emergency release pressure for modulating the parking brake pressure at the at least one spring accumulator connection.

19. The method of claim 18, wherein the emergency release pressure is input into an air-purging path of the solenoid valve.

20. The method of claim 18, wherein the emergency release pressure is modulated at the safety control connection of the electromagnetic solenoid valve or at a further control connection of the electromagnetic solenoid valve.

21. A method for controlling a parking brake function of a commercial vehicle having an electropneumatic brake system, wherein the electropneumatic brake system includes an electropneumatic valve arrangement having a pilot control unit and a main valve unit, the pilot control unit includes an electromagnetic solenoid valve having at least one first permanent magnet, wherein the pilot control unit is configured to modulate a pilot pressure in dependence upon an electronic parking brake signal, the main valve unit is configured to receive the pilot pressure and modulate a parking brake pressure at least at one spring accumulator connection in dependence upon the pilot pressure, the electromagnetic solenoid valve has a safety control connection for receiving a safety control pressure, the electromagnetic solenoid valve is configured to supply the pilot control unit with a supply pressure or connect the pilot control unit to an air-purging in dependence on the safety control pressure, wherein the safety control pressure is a pressure modulated by the electromagnetic solenoid valve or a pressure derived from the electromagnetic solenoid valve, the method comprising:
electromagnetically switching the electromagnetic solenoid valve from an air-purging position into an air-supplying position for modulating the parking brake pressure at least at one spring accumulator connection for supplying air to at least one spring-loaded brake cylinder;
at least one of confining the pilot pressure modulated by the electromagnetic solenoid valve and holding the electromagnetic solenoid valve in the air-purging position; and,
when the supply pressure provided to the electromagnetic solenoid valve drops below a first threshold value: pneumatically or mechanically switching the solenoid valve into the air-purging position.

22. A commercial vehicle comprising an electronically controllable pneumatic brake system, wherein said electronically controllable pneumatic brake system includes the electropneumatic valve arrangement of claim 1.
